(19) United States
(12) Patent Application Publication
(10) Pub. No.: US 2006/0103878 A1
(43) Pub. Date: May 18, 2006

(54) Digital image output method

(75) Inventors: Yung-Chuan Wu, Pingjhen City (TW); Bo-Hsiang Wang, Taiping City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AVISION INC.

(21) Appl. No.: 11/283,198

(22) Filed: Nov. 18, 2005

(30) Foreign Application Priority Data
Nov. 18, 2004 (TW) 93135500

(51) Int. Cl. G06F 3/12

(52) U.S. Cl. 358/1.15

(57) ABSTRACT

A digital image output method includes the steps of selecting a number of output modules to output image data via a control center, and equally distributing the image data to the selected output modules for print in order.

This application claims the benefit of Taiwan application Serial No. 93135500, filed Nov. 18, 2004, the subject matter of which is incorporated herein by reference.

### BACKGROUND OF THE INVENTION

1. Field of the Invention

The invention relates in general to a digital image output method, and more particularly to a digital image output method of smartly distributing multiple image output tasks to multiple printing modules.

2. Description of the Related Art

With the coming of the digital image age, the conventional photography labs have gradually transformed into digital photography labs in order to satisfy the increasing demands of users on the digital images and provide a convenient digital image output channel.

FIG. 1 is a schematic block diagram showing a conventional digital image output procedure. As shown in FIG. 1, when a customer 110 asks for a store 120 (i.e., digital photography lab) to develop the film and print the photos, the store 120 usually sends the film or image data to a central output center 130 to develop the film and print the photos. The output center 130 mails the developed and printed photos to the store 120, and finally the photos are sent to the customer 110. However, it takes one day or more than one day for the customer 110 to get the photos after the central output center 130 has processed and outputted the data and sent the printed photos to the store 120. Thus, the conventional method cannot satisfy the customer's demand on the speed of developing and printing and cannot achieve the real time service. In addition, because the system in the central output center 130 is very expensive, the ordinary consumer cannot afford to pay the fee.

### SUMMARY OF THE INVENTION

It is therefore an object of the invention to provide a digital image output method capable of smartly distributing image outputting tasks to several output modules via a control center so as to increase the image output speed effectively with the low apparatus cost. Thus, it is unnecessary to send the images to the central output center, and the store can process the images and print the photos with an enhanced image output efficiency.

The invention achieves the above-identified object by providing a digital image output method used in an image output system, which comprises a control center and n output modules. The control center receives p sets of image data, wherein n and p are positive integers greater than 1. The digital image output method includes the steps of: selecting m output modules to output the image data via the control center, wherein m is a positive integer greater than 1 and smaller than or equal to n; and equally distributing the p sets of image data to the m output modules for print in order. Thus, the control center can smartly distribute the image data to a number of output modules for print and output in order with an enhanced image output efficiency.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic block diagram showing a conventional digital image output procedure.

FIG. 2 is a block diagram showing a digital image output architecture according to a preferred embodiment of the invention.

FIG. 3 is a flow chart showing a digital image output method according to a preferred embodiment of the invention.

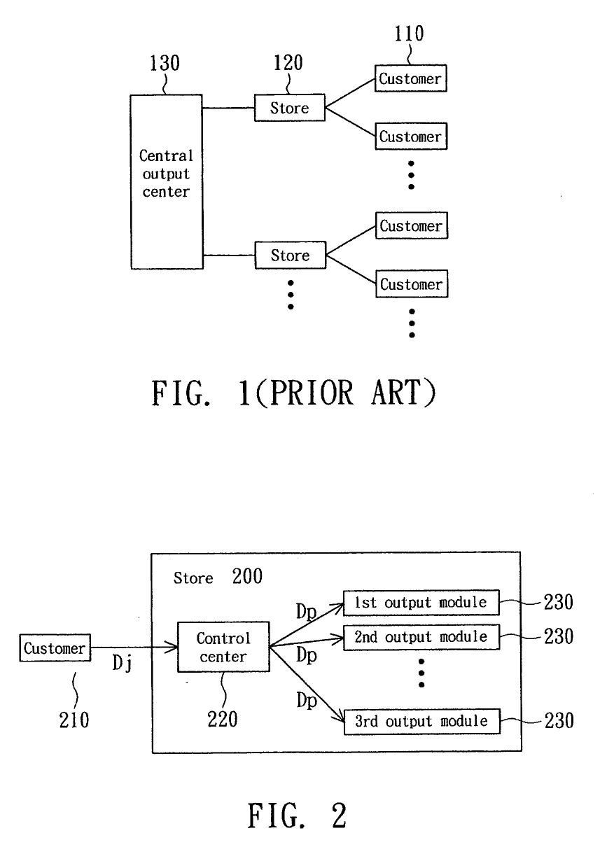

### DETAILED DESCRIPTION OF THE INVENTION

FIG. 2 is a block diagram showing a digital image output architecture according to a preferred embodiment of the invention. The store 200 inputs p sets of digital image data Dd, such as photograph images or invoice images, sent from the customer 210, to the control center (e.g., a computer host) 220 for processing the images, wherein p is a positive integer greater than 1. Then, the control center 220 distributes the processed image data Dp to n output modules 230, such as inkjet printers, for print and output, wherein n is a positive integer greater than 1, and n is 15 in this example.

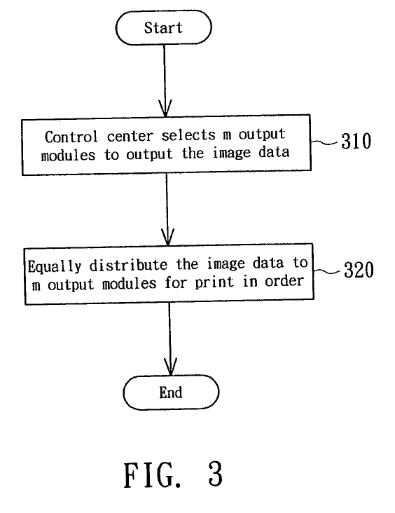

FIG. 3 is a flow chart showing a digital image output method according to a preferred embodiment of the invention. First, step 310 selects m output modules 230 to output the image data via the control center 220 according to the setting of the store 200, wherein m is a positive integer, such as 15, greater than 1 and smaller than or equal to n. Next, step 320 equally distributes the p (e.g., 150) sets of image data Dp to the m output modules 230 for print in order. In order to meet the image order requested by the customer 210 without disorder, the control center 220 equally distributes the p sets of image data Dp to the 1st to m-th output modules 230 for print by taking an integral ratio of Q (=p/m) as one unit.

For example, if Q=150/15=10, the control center 220 distributes the first ten sets of image data Dp, including the 1st to 10th sets of image data, to the 1st output module 230 for print and output, the second ten sets of image data Dp, including the 11th to 20th sets of image data, to the 2nd output module 230 for print and output, and so on, and finally distributes the ten sets of image data Dp, including 141st to 150th sets of image data, to the 15th output module 230 for print and output.

Of course, this distributing method bases on the principle of equally distributing the image data without disordering the image order. However, when the ratio Q is not an integer, it is possible to truncate Q to an integral ratio k. The control center 220 equally distributes the image data Dp to the 1 st to m-th output modules 230 for print in order by taking the integral ratio k as one unit, and the residual image data Dp after the distribution are sent to the m-th output module 230 for finishing the printing tasks. For example, if Q=200/15=13.3, the integral ratio k is 13. The control center 220 distributes the 1st to the 13th sets of image data Dp to the 1st output module 230 for print, distributes the 14th to the 26th sets of image data Dp to the 2nd output module 230 for print, and so on, and finally distributes the 182nd to the 195th sets of image data Dp to the 15th output module 230 for print. The residual 5 sets of image data Dp are sent to the 15th output module for finishing the printing tasks.

Alternatively, it is possible to round Q into an integral ratio k. The control center 220 equally distributes the sets of image data Dp to the 1st to the (m−1)-th output modules for print in order by taking the integral ratio k as one unit, and the residual image data Dp after the distribution are sent to the m-th output module 230 for print. For example, if Q=200/15=13.3, the integral ratio k is 14. The control center 220 distributes the 1st to the 14th sets of image data Dp to the 1st output module 230 for print, distributes the 15th to the 28th sets of image data Dp to the 2nd output module 230 for print, and so on, and finally distributes the 183rd to the 196th sets of image data Dp to the 14th output module 230 for printing. The residual 4 sets of image data Dp are sent to the 15th output module for print.

Furthermore, when the control center 220 wants to distribute the 150 sets of image data Dp to the 15 output modules 230 for print and to print the data Dp on the 15 output modules 230 simultaneously in the time order requested by the customer 210, the control center 220 can smartly transfer the first set of data Dp (i.e., the 1st, 11th, 21st, to 141 sets of data Dp) in each of the 15 groups of ten-sets data Dp to the 1st to 15th output module 230s for print in order simultaneously. Then, the control center 220 transfers the second set of data Dp (i.e., 2nd, 12th, 22nd to 142nd sets of data Dp) in each of the 15 groups of ten-sets data Dp to the 1st to the 15th output modules 230 for print simultaneously. Analogically, the control center 220 transfers the tenth set of data Dp (i.e., 10th, 20th, 30th to 150th sets of data Dp) in each of the 15 groups of ten-sets data Dp to the 1 st to the 15th output modules 230 for print simultaneously.

Inversely, if the control center 220 transfers the sets of image data Dp to the 1 st, 2nd to 15th output modules 230 for print one by one, the order of the documents printed by each output module 230 corresponds to the 1 st, 16th, 31st to 136th sets of image data Dp. Consequently, the image order requested by the customer may be disordered completely.

As mentioned hereinabove, the store 200 can set the control center 220 to transfer the image data Dp to all (15) output modules 230 for print and output according to the urgent case demand of the customer 210. When any one of the 15 output modules 230 has an error or insufficient consumable materials such as the ink and printing sheets, the image data Dp transferred to the output module are printed and output by a normal output module 230 after other output modules 230 have all finished their data outputting tasks.

Alternatively, the store 200 may adopt a more flexible method of setting the control center 220 to send the image data Dp to a large fraction of the output modules 230 (e.g., 13 output modules) for print and output in response to the urgent case demand of the customer 210. The residual two output modules 230 are on standby. When any one of the 15 output modules 230 has an error or insufficient consumable materials such as the ink and the printing sheets, the control center 220 can transfer the image data Dp that are not printed by the output module 230 to the two standby output modules 230 for print.

In addition, the store 200 may also set the control center 220 to transfer the image data Dp to a small fraction of output modules 230 (e.g., 5 output modules) for print when the customer 210 does not want to get the photos urgently, and the residual ten output modules 230 are on standby. When another customer 210 has an urgent case, the large fraction of the standby output modules 230 can be used for print. Of course, it is possible to reserve 1 or 2 output modules 230 for standby to deal with the condition of occasional failure of the output module 230 or the condition of insufficient consumable materials by taking the unfinished printing tasks.

The digital image output method according to the embodiment of the invention has the advantage of equally distributing multiple sets of digital image data to the available output modules for print and output in order according to the customer's requirement. Some of the output modules may be reserved for standby to complete the unfinished tasks in response to the abnormal operation or insufficient consumable materials of the output module. Therefore, the main costs for implementing the image output method include the cost of the control center (computer host) and the cost of the output modules. However, the best computer host available in the market costs not more than thirty thousand NTDs (New Taiwan Dollars), and the highly advanced inkjet printer only costs several thousands of NTDs. Thus, the cost for implementing the image output method of the invention is far less than that (several million NTDs) for the conventional digital photography lab to print the photos by using the central output center. Thus, it is possible to save the cost and time for delivering the documents, which have been printed in the central output center, back to the store, and the consumer can enjoy the advantage of getting the photos in real time.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A digital image output method, used in an image output system comprising a control center and n output modules, the control center receiving p sets of image data, wherein n and p are positive integers greater than 1, the digital image output method comprising steps of:
selecting m output modules to output the p sets of image data via the control center, wherein m is a positive integer greater than 1 and smaller than or equal to n; and
equally distributing the p sets of image data to the m output modules for print in order.

2. The method according to claim 1, wherein the control center equally distributes the p sets of image data to the m output modules for print in order by taking an integral ratio k as one unit, wherein k is an integer approximating p/m.

3. The method according to claim 2, wherein the integral ratio k is obtained by truncating p/m to an integer, the control center equally distributes the p sets of image data to 1st to m-th output modules for print in order by taking the integral ratio k as one unit, and the m-th output module finishes printing the residual sets of image data after distribution.

4. The method according to claim 3, wherein the control center can smartly transfer an i-th set of image data in each k sets of image data among the p sets of image data to the 1st to the m-th output modules for print in order simultaneously, wherein i ascends from 1 to k.

5. The method according to claim 2, wherein the integral ratio k is obtained by rounding p/m into an integer, the control center equally distributes the p sets of image data to 1st to (m−1)th output modules for print in order by taking the integral ratio k as one unit, and an m-th output module finishes printing the residual sets of image data after distribution.

6. The method according to claim 5, wherein the control center can smartly transfer an i-th set of image data in each k sets of image data among the p sets of image data to the 1st to the (m−1)th output modules for print in order simultaneously, wherein i ascends from 1 to k.

7. The method according to claim 1, wherein the control center transfers the p sets of image data to the n output modules for print and output.

8. The method according to claim 1, wherein the control center transfers the p sets of image data to a large fraction of the output modules for print and output, and reserves a small fraction of the output modules for standby, such that the control center transfers the image data, which are not printed in an output module working abnormally or having insufficient consumable materials, to the standby output modules for print.

9. The method according to claim 1, wherein the control center transfers the p sets of image data to a small fraction of the output modules for print and output, and reserves a large fraction of the output modules for standby and printing image data in urgent cases.
